(19) United States
(12) Patent Application Publication
(10) Pub. No.: US 2008/0158681 A1
(43) Pub. Date: Jul. 3, 2008

(54) Optical Diffuser Structure For Field Emitting Display Element

(76) Inventors: Shih-Chien Hsiao, Taipei City (TW); Chang-Jen Huang, Taipei City (TW); Ming-Chun Ho, Taipei City (TW); Pu-Hsin Chang, Taipei City (TW); Yi-Ting Chung, Taipei City (TW)

Correspondence Address: HDSL, 4331 STEVENS BATTLE LANE, FAIRFAX, VA, 22033, US

(21) Appl. No.: 11/618,826

(22) Filed: Dec. 30, 2006

(51) Int. Cl. G02B 5/02

(52) U.S. Cl. 359/599

(57) ABSTRACT

An optical diffuser structure for field emitting display element provides uniform lightness contrast to a display, and includes a glass substrate as main body, wherein plural black stripe blocking layers is arranged on the panel of the substrate for covering the light diffusing path of the display element, a transparent glue layer being further arranged on the surfaces of the black stripe blocking layer and glass substrate, thus the black stripe blocking layer is protected from the damage caused by sandblasting process, at last, a nebulized surface is formed on the transparent glue layer, thereby, through the diffuser structure, the light generated by the display element possesses a uniformity without any reduction and loss of lightness.

### BACKGROUND OF THE INVENTION

1. Field of the Invention

The present invention generally relates to an optically diffusing structure, in particular, to a diffuser structure attached onto the surface of a field emitting display element.

2. Description of Prior Art

Recently, due to its light and thin characteristics and superiority of performance to the traditional TV in terms of resolution and lightness of picture quality, flat panel display is comprehensively available to display markets with different sizes, from small cellular phone screen to large outdoors commercial board. The application of flat panel display has already become a fashion to been frequently seen in current appliance market.

Accordingly, various flat panel displays are continuously emerging in current market, including: liquid crystal display (LCD), plasma display panel (PDP), organized light-emitting diode (OLED), and field emitting display (FED). In particular, FED is one of recently developed flat panel display, interior structure of which is arranged a cathode electron emitting source for generating electron beam to impinge corresponding fluorescent layer to generate light that may provide sufficient lightness for the provision of light source to the flat panel display.

Since the lighting surface of field emitting display is provided by point light sources constituted by plural lighting points generated by fluorescent layer, the installing density of lighting points will directly influence the uniformity of lighting surface. Therefore, when the nano-carbon-tubes functioned as the cathode electron emitting sources are unevenly distributed or some are spaced with large distances, the lighting surface of display will generate apparent gaps or dark areas, causing the occurrence of a situation: the uniformity of images shown by display is poor.

To overcome above shortcoming of poor uniformity, the prior arts provide a diffuser structure that may be applied as an interior backlight source of LCD, the lighting points generated by which may be diffused and uniformed by the nebulized structure arranged on the diffuser structure, and thus a uniform lightness can be provided. However, although the nebulized structure formed on the diffuser may uniform the light source, the nebulizing degree will be attenuated due to the reflection of light generated from the backlight source, this phenomenon directly influencing the transmittance and the lightness contrast of display substantially. In the meanwhile, the loss of lightness contributes lots of energy consumption, which is contradictory to the current policy of energy saving. Accordingly, the aforementioned drawback becomes a problem urgently to be solved by those who are skilled in such arts.

### SUMMARY OF THE INVENTION

Regarding aforementioned drawbacks, the present invention is to provide an optical diffuser structure, which possesses enhanced lightness and high uniformity for the field emitting display element, and on which a structure of blocking layer and transparent glue layer with specific thickness is arranged for diffusing the direction and length of light path, so that the dependence of nebulized surface may be reduced and the lightness-reducing state may be mitigated. Finally, a nebulized surface with low percentage is arranged on the surface of the blocking layer, such that the transmitting light may be uniformed sufficiently for the provision of an optimal lightness contrast.

The invention provides an optical diffuser structure for field emitting display element, wherein said structure being comprised of a glass substrate as main body, plural black stripe blocking layers being arranged on the panel of said substrate for covering the light diffusing path of said display element, a transparent glue layer being further arranged on the surfaces of said black stripe blocking layer and said glass substrate, thus said black stripe blocking layer being protected from the damage caused by sandblasting process, at last, a nebulized surface being formed on said transparent glue layer, thereby, through said diffuser structure, the light generated by said display element possessing an uniformity without any reduction and loss of lightness.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a structurally sectional illustration of the present invention;

FIG. 2 is a sectional diagram of first processing step for manufacturing the diffuser according to the present invention;

FIG. 3 is a sectional diagram of second processing step for manufacturing the diffuser according to the present invention; and

FIG. 4 is a sectional diagram of third processing step for manufacturing the diffuser according to the present invention.

### DETAILED DESCRIPTION OF THE INVENTION

In cooperation with attached drawings, the technical contents and detailed description of the present invention will be as follows.

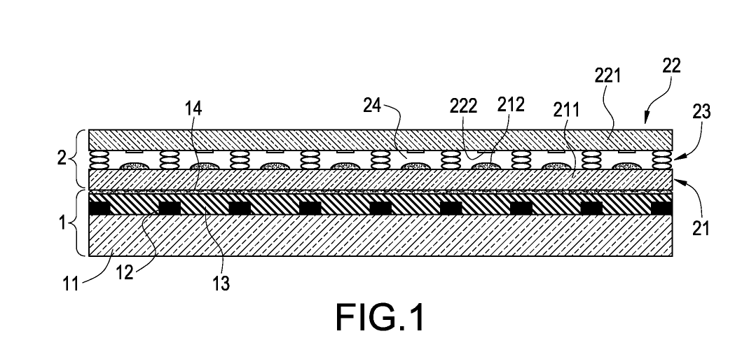

Please refer to FIG. 1, which is a structurally sectional illustration of the present invention. As shown in this figure, the diffuser 1 of the invention is arranged correspondingly on the light-transmitting area of a field emitting display element 2, wherein said field emitting display element 2 is correspondingly assembled by an anode plate 21 and a cathode plate 22, between which plural blockers 23 are arranged, furthermore, said anode plate 21 including an anode substrate 221 and plural fluorescent layers 212, while said cathode plate 22 including a cathode substrate 221 and plural cathode electron emitting sources 222 corresponding to plural fluorescent layers 212.

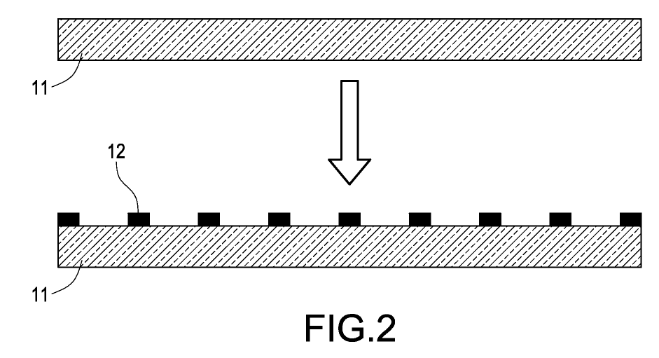

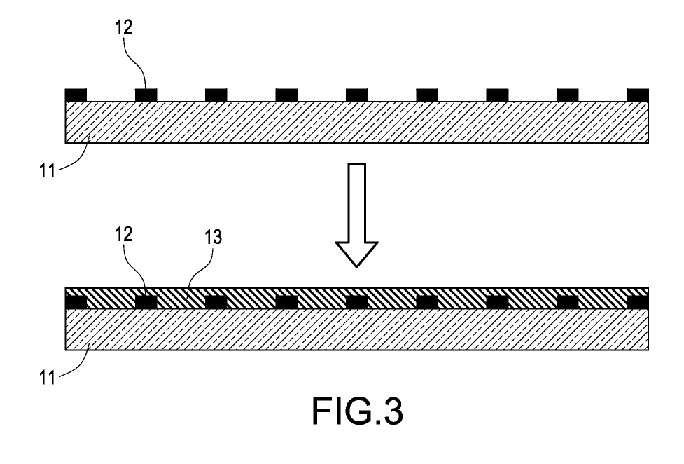

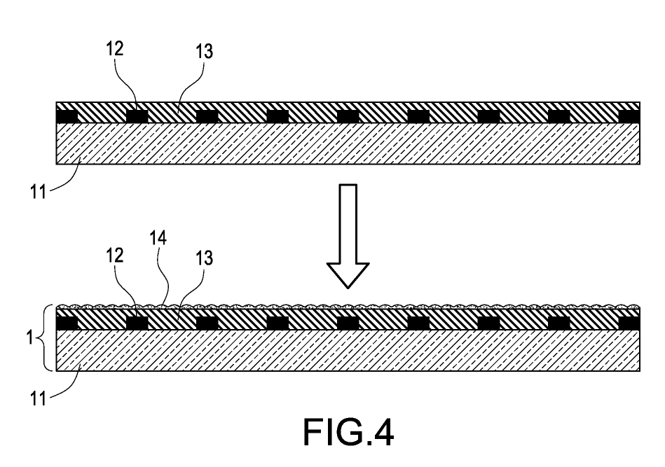

Please refer FIG. 2 through FIG. 4, which separately are sectional diagrams of the processing steps for manufacturing the diffuser of the present invention. As shown in FIG. 2, the diffuser 1 of the invention is mainly comprised of a substrate 11, which is made of the material of glass, plural black stripe blocking layers 12 being arranged on the panel of said substrate 11, wherein glass powders and graphite are mainly used to constitute said black stripe blocking layers 12, the positions of which are just corresponded to those of blockers 23 of said display element 2, and which are made by web-printing or photolithography process, which thermally bakes and crystallizes the glass powders contained in said black stripe blocking layer 12, the thickness of which is between 10 micrometer and 20 micrometer. After that, a transparent glue layer 13 is further covered on said black stripe blocking layer 12. As shown in FIG. 3, said transparent glue layer 13 constituted by glass glue is simultaneously covered on the surfaces of said black stripe blocking layer 12 and said glass substrate 11. In the meantime, said black stripe blocking layer 12 is shorter than said transparent glue layer 13, the thickness error determining the surface flatness of which is less than 1 micrometer. Thus, after said transparent glue layer 13 has been thermally sintered with temperature higher than 560° C., besides said transparent glue layer 13 being formed into transparent state, the surface of said glass glue layer 13 is formed as a plane state with uniform flatness. Finally, as shown in FIG. 4, a sandblasting process is further executed on the surface of said transparent glue layer 13, which is then formed into a nebulized surface with an optimally nebulizing state of 50% nebulization.

Thereby, after the light, generated by said display element 1, is transmitted out of said anode plate 21, its path is extended and diffused by said transparent glue layer 13, such that its lightness is uniformed effectively. In the meanwhile, its lightness contrast is enhanced by partially covering the light diffusing path with said black stripe structure, reducing the dependence on nebulized structure. Finally, the light is optimized to a uniform state by passing through the nebulized surface 14 formed on the surface of said transparent glue layer 13.

Aforementioned description is only preferable embodiment according to the present invention, being not used to limit its executing scope. Any equivalent variation and modification made according to appended claims is all covered by the claims claimed by the present invention.

What is claimed is:

1. An optical diffuser structure for field emitting display element, comprising:
a substrate, which is arranged correspondingly on the light-transmitting area of the display element;
a black stripe blocking layer, which is arranged on the substrate;
a transparent glue layer, which is covered on the surfaces of the panel of the substrate and the black stripe blocking layer for protecting the surface of the black stripe blocking layer; and
a nebulized surface, which is formed on the surface of the transparent glue layer.

2. The optical diffuser structure for field emitting display element according to claim 1, wherein the substrate is constituted of glass.

3. The optical diffuser structure for field emitting display element according to claim 1, wherein the black stripe blocking layer is constituted of glass powder and graphite.

4. The optical diffuser structure for field emitting display element according to claim 1, wherein the thickness of the black stripe blocking layer is between 10 micrometer and 20 micrometer.

5. The optical diffuser structure for field emitting display element according to claim 1, wherein the thickness error determining the surface flatness of the transparent glue layer is less than 1 micrometer.

6. The optical diffuser structure for field emitting display element according to claim 1, wherein the transparent glue layer is constituted of glass glue.

7. The optical diffuser structure for field emitting display element according to claim 1, wherein the nebulizing degree of the nebulized surface is 50%.

8. The optical diffuser structure for field emitting display element according to claim 1, wherein the transparent glue layer is higher than the black stripe blocking layer.
